(19) United States
(12) Patent Application Publication
(10) Pub. No.: US 2026/0168374 A1
(43) Pub. Date: Jun. 18, 2026

(54) IMAGING FLUID COMPRISING A PLANT-BASED OIL, AND METHOD FOR SUBSURFACE IMAGING IN A BOREHOLE

(71) Applicant: NOVAMERA INC., Oakville (CA)

(72) Inventors: Steve BUTT, St. John's (CA); Zijian LI, Henan (CN); Prajit PREMRAJ, St. John's (CA)

(73) Assignee: NOVAMERA INC., Oakville, ON (CA)

(21) Appl. No.: 19/125,127

(22) PCT Filed: Sep. 29, 2023
(86) PCT No.: PCT/CA2023/051297

§ 371 Date: Apr. 28, 2025

Related U.S. Application Data
(60) Provisional application No. 63/381,599, filed on Oct. 31, 2022.

(51) Int. Cl. E21B 47/002; C09K 8/035; C09K 8/34; E21B 47/09; G01S 13/88; G01V 3/30

(52) U.S. Cl. CPC E21B 47/0025; C09K 8/035; C09K 8/34; G01S 13/885; G01V 3/30; E21B 47/09

(57) ABSTRACT

The present application pertains to an imaging fluid and a method for subsurface imaging, such as that of electromagnetic imaging, comprising introducing said imaging fluid into a borehole. The imaging fluid comprises a plant-based oil, a drilling fluid weighting agent and a saturated fatty acid, and has the properties of a dielectric permittivity of from 2 to 5 and a density greater than water. In one example, the imaging fluid is comprised of: canola oil or castor oil 40-75%, stearic acid 1-10%, and barium sulfate 15-45%, all percentages are weight by total weight of the imaging fluid.

### FIELD

The invention is directed to an imaging fluid and method for employing it and, in particular, an imaging fluid and method for borehole electromagnetic imaging.

### BACKGROUND

Borehole electromagnetic imaging methods may employ electromagnetic sensors and are useful for subsurface imaging. These methods and sensors have already been applied in a variety of engineering and environmental applications. For example, electromagnetic sensors have been employed for the identification of subsurface cavities, investigation of underground water leakage and location of fractures in rock.

Electromagnetic sensors employ, for example, ground penetrating radar.

If a liquid, such as water, with a different dielectric permittivity than the lithology is present in the borehole, it can have an adverse effect on electromagnetic sensor imaging quality. For example, the relative dielectric permittivity of water is very high (i.e. for example, 81) comparing to soil and rock (i.e. between 4 and 10) that is encountered in most borehole electromagnetic surveys. As a result, the reflection coefficient of the water-wellbore boundary is very large, with ˜20% to 40% of the wave energy bouncing back from the water-wellbore interface. This becomes a significant noise source that interferes with the electromagnetic imaging quality. The poor reflection coefficient also induces a reduction in the penetration depth of the radar wave.

Groundwater also causes attenuation of the electromagnetic waves because of its conductivity. The water's dissolved salts increase the electric conductivity and the level of attenuation of the electromagnetic signal. This reduces the signal-to-noise ratio and ultimately reduces both the quality of the electromagnetic image and the effective imaging penetration distance beyond the borehole wall.

Potential solutions for this groundwater problem are i) to remove the water from the borehole by pumping, which may not be practical in situations of high formation permeability, and ii) to use an oil-based imaging fluid. However, conventional oil-based fluids based on diesel oil are not environmentally suitable, and oil-based fluids based on plant oils can easily separate from the water so that the oil rises to the top of the borehole and negates any imaging benefit.

### SUMMARY

In accordance with a broad aspect of the present invention, there is provided an imaging fluid comprising a plant-based oil, a drilling fluid weighting agent and a saturated fatty acid.

In accordance with another broad aspect of the invention, there is provided an imaging fluid based on plant-based oil and having the following characteristics: a dielectric permittivity of from 2 to 5; and a higher density than water.

In accordance with another broad aspect of the present invention, there is provided a method for subsurface imaging in a borehole comprising: introducing an imaging fluid comprised of a plant-based oil, a drilling fluid weighting agent and a saturated fatty acid to the borehole, generating imaging signals from an imaging device submerged in the imaging fluid.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### FIGURES

The following figures are attached to facilitate understanding of the invention.

FIGS. 1A to 1D are a series of drawings schematically illustrating a possible method according to the present invention.

FIG. 2 shows results from Example II, which are photos illustrating the stability of the imaging fluid.

FIG. 3 shows results from Example IV, which is a graph showing signal-to-noise ratio for different borehole scan conditions referenced against scans in air.

FIG. 4 shows results from Example IV, which is a graph showing energy at the borehole/formation interface for different borehole scan conditions.

### DETAILED DESCRIPTION

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

To address the problems with geophysical survey in a water-based environment, such as a water-containing borehole, an imaging fluid and methods have been invented. While other liquids may be present that have a different dielectric permittivity than the lithology, typically the liquid is water, including introduced or naturally occurring fresh or salt water or water-based drilling fluids. In the following description, therefore reference to water is intended to encompass any liquid that has a different dielectric permittivity than the lithology.

In particular, an imaging fluid has been invented, which is comprised of a plant-based oil, such as for example canola oil or castor oil, a drilling fluid weighting agent, such as for example barite, and a saturated fatty acid, such as for example, stearic acid.

### Composition:

The imaging fluid is comprised of a plant-based oil, a drilling fluid weighting agent and a saturated fatty acid.

The imaging fluid includes a plant-based oil. While various plant based oils could be used, the dielectric constant of the oil should be considered. In particular, oils that have a dielectric constant close to that of rock are of interest, such as plant-based oils having a relative dielectric permittivity of between 2 and 5. For example, the oil can be canola oil, which has a relative dielectric permittivity of around 2.5 to 2.7 and/or castor oil, which has a relative dielectric permittivity of around 4.1 to 4.3. While other plant based oils could be used, canola and castor oils have a good dielectric constant at borehole conditions.

Drilling fluid weighting agents are known. The drilling fluid weighting agent may be selected based on environmental acceptance, availability and cost. In one embodiment, the drilling fluid weighting agent is a barite. Various sources of barite are known, some of which are mixtures with other compounds. Sources containing at least 65% wt and possibly 70% wt barium sulfate are of greatest interest. Barites with lower concentrations of silica, such as SiO₂ containing compounds (<30% wt or <6% wt) and conductive materials (<5% wt or <1% wt) such as those containing iron give better results. Barite according to the American Petroleum Institute (API) standard for use in drilling muds and micronized barite have both been found useful.

The saturated fatty acid of greatest interest is stearic acid. Stearic acid has been found to carry the weighting agent, for example barite, well.

Overall, the weighting agent is selected to give the imaging fluid a density greater than water, the fatty acid is employed to suspend the weighting agent and the plant-based oil is selected for its dielectric properties.

In one embodiment, the imaging fluid comprises (all w/w, weight based on the total weight of the fluid):
canola oil 40-75% or in some embodiments 57-72%;
stearic acid 1-10% or possibly 3-5%; and
barium sulfate 15-45% or possibly 24-40%.

Compositions can alternatively be made by replacing the canola oil with castor oil.

The imaging fluid has the following characteristics:
specific gravity of the fluid is greater than 1, for example, about 1.1-1.4, for example, about 1.2-1.3; and
the relative dielectric permittivity of the imaging fluid is between 2 and 5, for example, around 2.5 to 2.7 for a canola oil based imaging fluid or around 4.1 to 4.3 for a castor oil based imaging fluid.

The component concentrations can vary depending on the nature of the water in the borehole and other factors. For example, if the borehole contains brine, the composition may be adjusted to achieve a specific gravity more appropriate for brine.

The plant-based oil, drilling fluid weighting agent and saturated fatty acid are combined to prepare the imaging fluid. It may be useful to melt the saturated fatty acid into at least a portion of the oil, prior to adding the barite. In one embodiment, a portion of the oil and the saturated fatty acid is heated to at least 50° C. and then the barite is blended into the heated combination. If the barite is less fine, the stability of barite within the imaging fluid is improved by heating the oil and saturated fatty acid to about 100° C. before adding the barite.

The imaging fluid addresses at least some of the main problems of groundwater on electromagnetic wave transmission and imaging quality. It also can address at least some of the major limitations of conventional oil-based imaging or drilling fluids, as described above.

### Methods:

The imaging fluid can be introduced to the wellbore to be imaged. If there is water in the wellbore, the density of the imaging fluid causes it to settle down at the bottom of the well (the bottom as determined by gravity). The imaging fluid can be introduced at surface and will flow down into the well by gravity. If there is water in the wellbore, the imaging fluid will sink through the water due the density of the imaging fluid being greater than water. A sufficient amount of imaging fluid is introduced to span the depth where the electromagnetic sensor is to be operated. Specifically, the imaging fluid is to be introduced to span the wellbore area where the imaging signals are to be generated and sensed.

The imaging fluid is positioned before or after the electromagnetic sensor is tripped into position in the well, but is in place when the imaging signals are to be generated and sensed.

The imaging fluid can be held in position by being supported in the borehole. For example, the imaging fluid can be introduced to reside in a lower limit, determined by gravity, of the borehole. For example, the imaging fluid can pool on bottom hole and the imaging tool sensors can be operated in the pooled imaging fluid. Alternatively, a plug, such as a removable plug, can be placed in the borehole below where the imaging tool is to be operated. The imaging fluid is retained in position above the plug and the imaging tool can be operated in the retained imaging fluid above the plug.

After the imaging process is complete, the imaging fluid can be removed from the borehole, as by being pumped out.

In one embodiment, the step of introducing the imaging fluid to the borehole includes: ensuring there is an opening through the drill string and through its distal end and introducing the imaging fluid into the wellbore via the drill string, where the imaging fluid flows out the distal end of the drill string, into the wellbore. Time can be taken to ensure that the imaging fluid is settled in a low point or on a plug in the borehole. The method can further include deploying an imaging device through the drill string and positioning a portion of the imaging device to extend out beyond a distal end of the drill string in the settled imaging fluid, such that the imaging signals are generated while signal generating and signal receiving components of the imaging device are submerged in the imaging fluid. When the imaging process is complete, the imaging device and the imaging fluid can both be returned to surface via the drill string inner bore.

In one embodiment, the borehole may be drilled with a core bit installed on the end of a core barrel, which is installed on the end of a drill pipe. In such an embodiment, when it is desired to image the borehole, the imaging tool can be run in through the drill pipe inner diameter and operated at an end of the core barrel. In one embodiment, at least the sensor portion of the imaging tool is extended through the open port of the core bit. Obstructions, such as the core tube and/or core, in the drill string may be removed to ensure that the imaging tool can be run in.

The imaging process can be used in a mining by drilling procedure, for example, to identify and accurately define the boundaries of an orebody prior to its extraction.

While this drilling assembly and method is described below, it is to be appreciated that the methods and tools described herein may be applicable to other drilling assemblies, imaging assemblies and methods. In this description, sometimes, core barrel, drill string and drill pipe are used interchangeably.

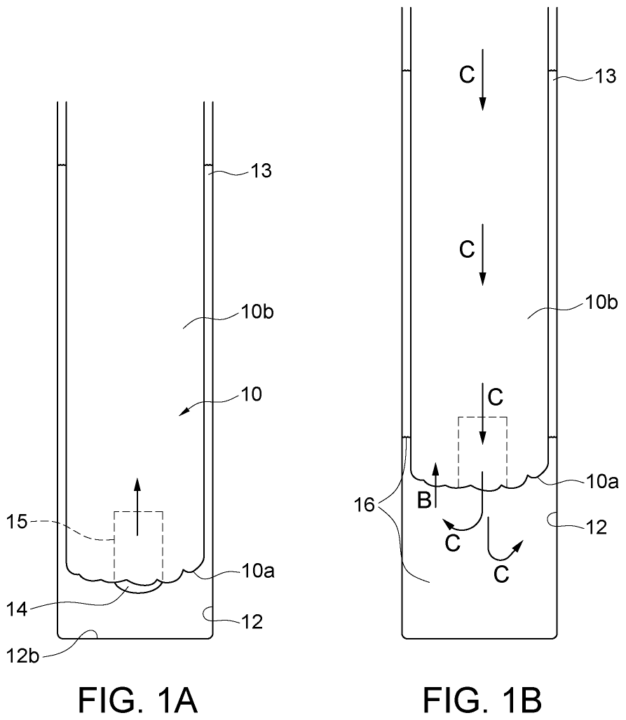

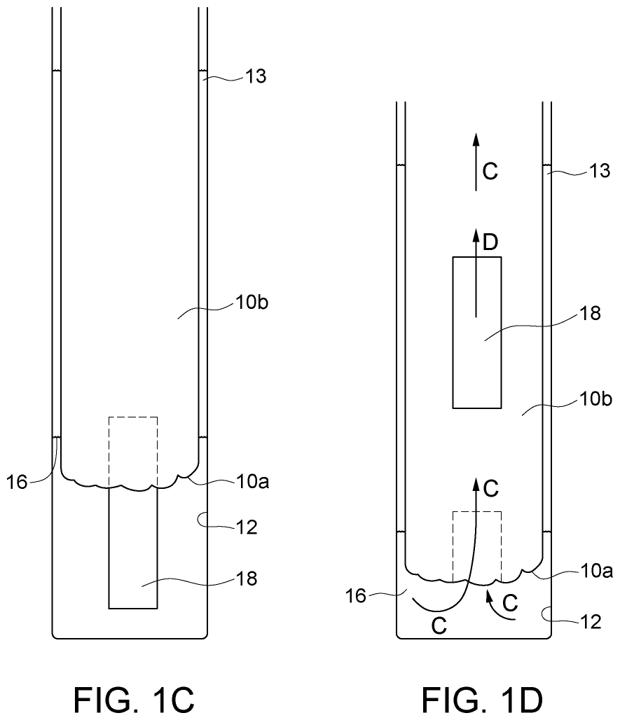

In one embodiment as shown in FIGS. 1A to 1D, the imaging fluid is used in a core drill operation. As shown in FIG. 1A, when a core drill assembly 10 has drilled a borehole 12, it may be desirable to image the borehole and surrounding formation. The borehole may contain water-based liquids such as groundwater 13, drilling fluid, etc. The core tube 14 containing the core is pulled up, arrow A, out of an open end 15 of the drill head 10a and through the drill string 10b. As shown in FIG. 1B, the drill head 10a is then pulled up, arrow B, off bottom hole 12a. Imaging fluid 16 is introduced, arrows C, down the drill pipe and allowed to settle in the borehole at bottom hole 12a. Due to the imaging fluid 16 having a density greater than water, the imaging fluid settles below the groundwater 13 for example at a low point in the well or above an installed plug. When the imaging fluid is introduced, any groundwater is displaced upwardly via natural displacement.

As in FIG. 1C, the electromagnetic sensor 18 is then deployed through the drill string and positioned in the settled imaging fluid. The electromagnetic transmitters and sensors 18 are positioned extending out beyond the distal end of the drill string into the borehole. Signals are generated by sensor 18 while signal generating and signal receiving components are immersed in the imaging fluid. Imaging data is captured for example to identify and accurately define the boundaries of an orebody prior to its extraction.

As in FIG. 1D, the sensor 18 is then retrieved, arrow D and the imaging mud is pumped out, arrows C.

The electromagnetic sensor may be any of various types. Generally, the imaging fluid facilitates use of electromagnetic sensors that employ frequencies within the electromagnetic spectrum, such as 5 MHz to 130 GHz. In one embodiment, the electromagnetic sensor employs ground penetrating radar (GPR).

For field applications of a borehole electromagnetic sensor, the new fluid has several main features and advantages compared to groundwater or prior oil-based drilling fluids:

### a) Appropriate Relative Dielectric Permittivity and Low Attenuation Coefficient

The relative dielectric permittivity of the new imaging fluid is between 2 and 5, for example, between 2 and 3 when the imaging fluid is based on canola oil. The relative dielectric permittivity of a typical subsurface formation (i.e. soil and rock) ranges between 4 and 10. Thus, after substituting the groundwater with the imaging fluid, the corresponding energy of a reflected wave from the imaging fluid-wellbore interface takes 2% to 12% (depending on the formation lithology) of the initial wave energy. Using the imaging fluid, the energy of reflected wave is reduced by a large amount compared with the situation where the groundwater is in the wellbore. As a result, the signal-noise ratio increases and the imaging quality is improved. In addition, the attenuation coefficient of the imaging fluid, as an oil-based fluid, is much lower than the groundwater. Then, the signal amplitude will increase accordingly.

b) Higher Density than Water

The imaging fluid is an oil-based fluid, however, with a higher density than water. For example, the imaging fluid can have a density of 1.1-1.4 g/cm³ compared to water, which has a density of 1.0 g/cm³. This feature allows the imaging fluid to settle on the bottom of a water filled wellbore. When the imaging fluid is introduced to the wellbore in preparation for survey, the imaging fluid will replace the groundwater at the wellbore bottom. The electromagnetic sensor can be tripped in and operated in the imaging fluid. The imaging fluid will encapsulate the borehole electromagnetic sensor and enhance the imaging quality. In addition, the high density of the imaging fluid results in a higher pore pressure than groundwater, which prevents groundwater from flowing into the wellbore after the imaging fluid is introduced to the wellbore.

### c) Stability Under Water

In oil-based fluids, it is easy for the components to separate with the oil floating to the surface. The imaging fluid composition enables the imaging fluid to reach the bottom of a water filled wellbore. While it is oil-based, the imaging fluid remains stable in water for long periods of time, such as at least a week. This period of time ensures that there is a considerable period of stability when the borehole electromagnetic sensor survey can be conducted, making the field application of the imaging fluid practical.

### d) Environmentally Friendly Components

The composition of the imaging fluid is not harmful for the environment. The plant-based oil, such as canola oil, and the stearic acid come from natural products and do not adversely effect environmental systems. Barite is a mineral widely used in drilling engineering, due to its high density and its environment acceptance in the underground environment. These materials can also be handled with relative safety.

The following examples are intended to illustrate operability of the invention, but not to limit its scope.

### EXAMPLES

### Example I—Preparation of Imaging Fluid

Imaging fluid was prepared containing:
2306 g canola oil;
128 g of stearic acid; and
1166 g of API barite.

The following method was employed:
Separately weigh out the component materials.
Heat 20% of the canola oil together with the stearic acid up to 100° C. until the stearic acid melts.
Put the remaining 80% room temperature canola oil in a container and then add the hot oil & stearic acid mixture. Mix the oil until the fluid is clear without any solid wax.
Slowly add the barite into the container. A sieve was used to slow down the rate of adding and to separate the barite powder. Mix during the adding procedure and continue mixing for 10 minutes to obtain the pre-made mixture.

### Example II—Imaging Fluid Stability

100 mL of imaging fluid according to Example 1 was combined with 500 mL of room temperature tap water in a glass jar. This combination was held at room temperature for one month.

Another oil-based fluid was prepared including 2:1 volumes of canola oil to barite. 100 mL of that fluid was combined with 500 mL of room temperature tap water in a glass jar.

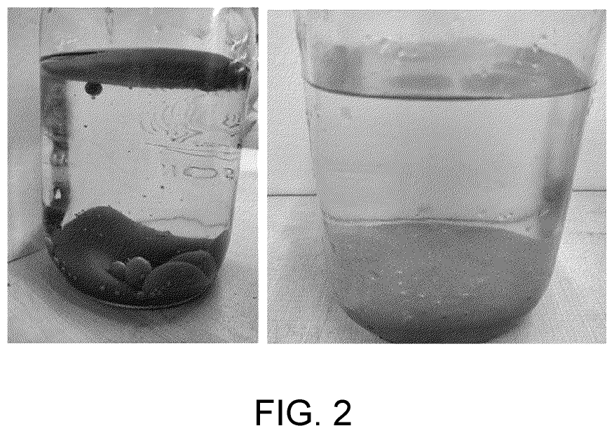

FIG. 2 shows on the left the oil-based drilling fluid in water after 15 minutes. As can be seen, the fluid began to show component separation after only 15 minutes. The right hand photo shows the present imaging fluid in water after more than one month. The imaging fluid shows no separation.

### Example III—Imaging Fluid Parameters and Stability

An imaging fluid according to Example 1 and controls: canola oil alone and a canola oil/stearic acid mixture (Oil/SA: 2700 g canola oil and 150 g stearic acid) were measured for magnetic susceptibility and conductivity using a multi-sensor core logger (MSCL) available from GeoTek Ltd. Measurements were made using the non-contact resistivity and magnetic susceptibility sensors of the MSCL machine according to the manufacturer's instructions.

Table I shows the measurements immediately after mixing.

TABLE I
Sample Measurements

| | Volume-specific Magnetic | Conductivity |
|---|---|---|
| Sample | Susceptibility (SI × 10\hat{ }−5) | (S/m) |
| Imaging fluid | 3.9 | 2.39 |
| Canola oil | −1.96 | 2.60 |
| Oil/SA | −2.25 | 2.68 |

It is noted that the non-contact resistivity sensor of the GeoTek Ltd. MSCL uses a frequency of 1.5 MHz, which is considerably lower than the frequency range of ground penetrating radar. The conductivity measured for the imaging fluid at 1.5 MHz is expected to higher than if the measurements were made at the ground penetrating radar frequencies of 250 MHz or 500 MHz. The magnitude of the difference is difficult to predict without having done the measurements, however, the relative conductivity for different specimens is expected to be the same for measurements at the lower or higher frequencies.

The magnetic susceptibilities measured in the lab are expected to be the same as encountered under field conditions using GPR frequencies. The negative magnetic susceptibilities measured in the lab are an artifact of measuring materials that are essentially nonmagnetic. Negative readings are the same as zero readings.

It was concluded that the imaging fluid had excellent characteristics of magnetic susceptibility and conductivity.

The samples were held at room temperature for three months. Measurements were repeated three further times over the three month period. Samples were mixed for 10 minutes prior to testing.

The imaging fluid remained stable with respect to magnetic susceptibility during the three month period. Conductivity dropped off in the first month, but stabilized thereafter. Overall, it was determined that the imaging fluid remained stable during the three month period.

### Example IV—Field Tests with Ground Penetrating Radar

At a private site in Newfoundland, Canada, tests were conducted in a borehole drilled in mafic/quartz rock. The borehole was 75.7 mm in diameter. The ground penetrating radar sensor measured 47 mm outer diameter and was housed in a polyvinylchloride plastic pipe of outer diameter 60.33 mm.

A 500 MHz ground penetrating radar imaging tool was employed.

Imaging fluid was prepared according to Example I. For field work, pre-made imaging fluid mixture was mixed for 10 minutes prior to use.

All tests were conducted at the same depth in the same borehole.

Tests were conducted using static scans. Static scans are where the data collection is along the same direction. In particular, once in place, the tool is not moved and the sensor acquires data only along one direction.

Three scan data sets were captured with the equipment: (i) the borehole filled with air, (ii) the borehole filled with the imaging fluid, and (iii) the borehole filled with naturally occurring ground water.

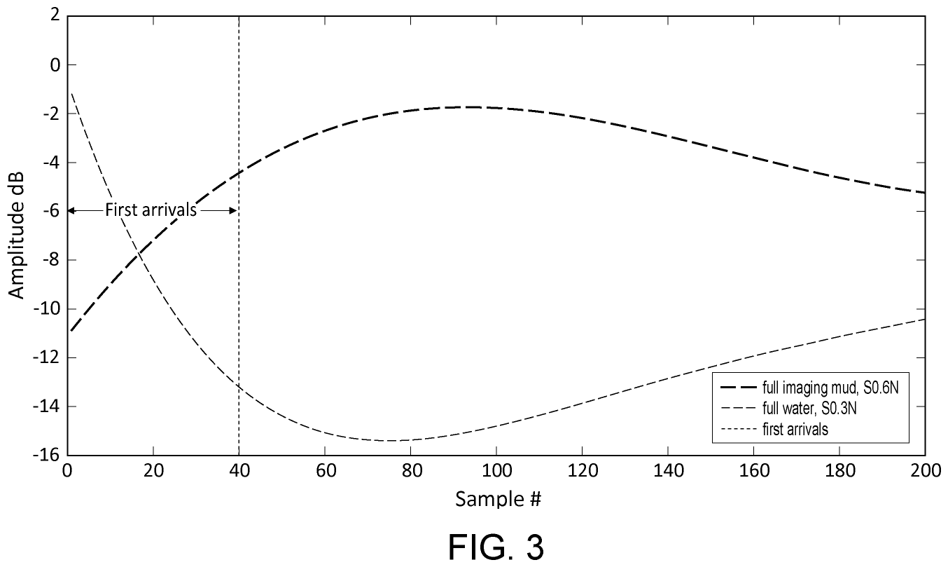

As expected, the best result is for an air filled borehole. The data for (ii) and (iii) was analyzed against the air filled data for signal to noise ratio (entire data space). The signal to noise ratio against the reference signal for air results are shown in FIG. 3 (SNR v. water thickness—Ref. signal: Air), wherein the significant improvement of imaging fluid over water is readily appreciated.

‘First Arrivals’ is the portion of the signal that goes directly from transmitter to receiver and/or the signal that reflects off the immediate interfaces around the sensor i.e. the plastic pipe or the hole wall. The first arrivals are, therefore, not considered to be signal that goes out into the geology and back to the receiver. The “First Arrivals” data is, therefore, ignored.

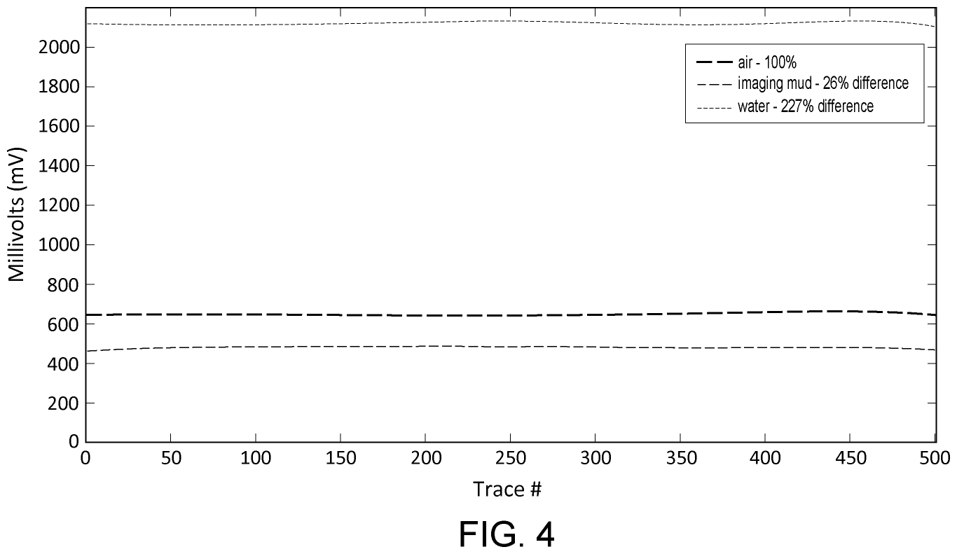

The data was also analyzed for energy strength at the interface of borehole and formation. The energy strength at the interface is calculated considering a window 5 ns above and 5 ns below the maximum energy peak. Because the scan acquired in air (i) is considered the baseline, this metric serves to quantitatively visualize the performance of other conditions in terms of imaging. Ideally, the strength at the interface is close to that of the air scan (i). FIG. 4 shows the energy profiles, plotted as traces against millivolts (mV), for the three conditions. The decay in energy strength of imaging fluid is less than 30% compared to air. The scan in water differs 230% from the scan in air.

### Example V—Preparation of Imaging Fluid with Castor Oil

An imaging fluid sample was prepared containing:
castor oil;
8 g/100 mL stearic acid; and
API barite to obtain a specific gravity of 1.2.

Another imaging fluid sample was prepared containing:
castor oil;
8 g/100 mL stearic acid; and
API barite to obtain a specific gravity of 1.3.

Each of these drilling fluids were tested for stability and flowability. These fluids were flowable and remained stable for seven days, when tested with room temperature tap water.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. An imaging fluid comprising: a plant-based oil, a drilling fluid weighting agent and a saturated fatty acid.

2. The imaging fluid of claim 1 wherein the plant-based oil is castor oil or canola oil, the drilling fluid weighting agent is barite and the saturated fatty acid is stearic acid.

3. The imaging fluid of claim 2 comprising:
canola oil 40-75% w/w;
stearic acid 1-10% w/w; and
barium sulfate 15-45% w/w.

4. An imaging fluid comprising: a plant-based oil and having the following characteristics: a dielectric permittivity of from 2 to 5; and a density greater than water.

5. The imaging fluid of claim 4, where the composition of the imaging fluid is:
castor oil or canola oil 40-75% w/w;
stearic acid 1-10% w/w; and
barium sulfate 15-45% w/w.

6. A method for subsurface imaging in a borehole comprising: introducing an imaging fluid comprised of a plant-based oil, a drilling fluid weighting agent and a saturated fatty acid to the borehole and generating imaging signals from an imaging device submerged in the imaging fluid.

7. The method of claim 6 wherein the imaging fluid comprises:
castor oil or canola oil 40-75% w/w;
stearic acid 1-10% w/w; and
barium sulfate 15-45% w/w.

8. The method of claim 6, wherein introducing the imaging fluid to the borehole includes:
introducing the imaging fluid down the drill string, such that it passes out of the drill string into the borehole and allowing time for the imaging fluid to settle in the borehole, and
wherein generating imaging signals from an imaging device submerged in the imaging fluid includes:
deploying the imaging device through the drill string and positioning a sensor portion of the imaging device to extend out beyond the distal end in the imaging fluid, such that the imaging signals are generated while signal generating and signal receiving components of the imaging device are submerged in the imaging fluid.

9. The method of claim 6, further comprising:
after generating, the imaging fluid is pumped out of the borehole.

10. The method of claim 6, further comprising:
removing an obstruction from the drill string before deploying the imaging device.

11. The method of claim 6, wherein the imaging fluid settles at a bottom of the borehole.

12. The method of claim 6, wherein the signals are electromagnetic signals.

13. The method of claim 12, wherein the electromagnetic signals are ground penetrating radar.
